(19) United States
(12) Patent Application Publication
(10) Pub. No.: US 2026/0344551 A1
(43) Pub. Date: Nov. 5, 2026

(54) Implement Safety Stop Arrangement

(71) Applicant: AGCO do Brasil Soluções Agrícolas Ltda., Jundiaí-São Paulo (BR)

(72) Inventor: Marcelo Carpenedo, Jundiaí-São Paulo (BR)

(21) Appl. No.: 19/662,866

(22) Filed: Apr. 29, 2026

(30) Foreign Application Priority Data
May 1, 2025 (GB) 2506708.3

(51) Int. Cl. A01B 63/02

(52) U.S. Cl. CPC A01B 63/02

(57) ABSTRACT

An actuator assembly for moving an implement attached to an agricultural vehicle has left- and right-hand side actuators attached to the implement at a connection point, a safety stop assembly with left- and right-hand side safety stops arranged parallel to one another, each actuator attached to the implement at a connection point. The actuator assembly has a first transverse rod supported for rotation about a first axis, the first transverse rod being provided at one end with a handle to enable rotation of the transverse rod so as to move the safety stops between a coupled position and an uncoupled position and left and right hand levers fixedly connected to the first transverse rod for rotation with the first transverse rod, mountings on each of the left and right hand side safety stops and couplings extending between one of the mounting points and an associated lever.

### CROSS-REFERENCE TO RELATED APPLICATIONS

This application claims the benefit of the filing date of U.K. Patent Application 2506708.3, “Implement Safety Stop Arrangement,” filed May 1, 2025, the entire disclosure of which is incorporated herein by reference.

### FIELD

Embodiments of the present disclosure relate generally to combine harvesters, and the feederhouse assembly used to deliver crop material to the threshing system of the combine harvester, and more particularly to a safety stop assembly for the feederhouse assembly.

### BACKGROUND

It is known to provide actuators to control the movement of a feederhouse assembly or other implement attached to a combine harvester housing or a header housing with respect to the combine harvester housing or the header housing. It is further known to provide safety stop arrangements associated with such actuators to prevent movement of the actuator beyond a given point, in particular to keep the feederhouse assembly or other implement from falling while an operator is beneath the feederhouse assembly or other implement, for example during servicing or maintenance.
As machines increase in capacity and size wider and heavier handlers will be constructed and so providing safety to an operator during any inspection or maintenance procedure is becoming increasingly important.

### BRIEF SUMMARY

According to a first aspect of the present invention, an actuator assembly for moving an implement attached to an agricultural vehicle comprises left and right hand side actuators, arranged parallel to one another, each actuator attached to the implement at a connection point, a safety stop assembly comprising left and right hand side safety stops, arranged parallel to one another, each attached to the implement at a connection point, characterised in that the actuator assembly further comprises
a first transverse rod supported from the agricultural vehicle for rotation about a first axis, the first transverse rod being provided at one end with a handle to enable rotation of the transverse rod so as to move the safety stops between a coupled position and an uncoupled position and left and right-hand levers fixedly connected to the first transverse rod for rotation with the first transverse rod
mountings on each of the left- and right-hand side safety stops and
couplings extending between one of the mounting points and an associated lever, each coupling being mounted for rotation with respect to each of the mounting point and lever, wherein
the actuator assembly further comprises left and right hand side inner safety stops, a second transverse rod supported from the agricultural vehicle for rotation about a second axis, the second transverse rod being provided at one end with a handle to enable rotation of the second transverse rod so as to move the inner safety stops between a coupled position and an uncoupled position and left and right hand levers fixedly connected to the second transverse rod for rotation with the first transverse rod and left and right hand levers fixedly connected to the transverse rod for rotation with the first transverse rod,
mountings on each of the left- and right-hand side inner safety stops and
couplings extending between one of the mounting points and an associated lever, each coupling being mounted for rotation with respect to each of the mounting point and lever and extending through an opening provided in each the associated safety stop.

This assembly has as an advantage that the safety stops are moved together.

Preferably, the actuator assembly further comprises a retention apparatus, the retention apparatus comprising a mounting secured to an exterior of the agricultural vehicle, a pivotable element secured to the mounting, the pivotable element provided with two or more abutment stops. More preferably, each abutment stop includes an abutment surface and an inclined surface.

Preferably, the connection point of each left- and right-hand safety stop is coincident with the connection point of the respective left- and right-hand side actuator.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The invention will now be described, by way of example only, with reference to the accompanying drawings, in which:

FIG. 1 shows a schematic side view of a known combine harvester;

FIG. 2 shows a first perspective view of a feederhouse assembly incorporating a first example of an actuator assembly with the actuator assembly in a coupled position;

FIG. 3 shows a second perspective view of the feederhouse assembly of FIG. 2 with the actuator assembly in a coupled position;

FIG. 4 shows the feederhouse assembly of FIG. 3 with the actuator assembly in an uncoupled position;

FIG. 5 shows a side view of the feederhouse assembly with the actuator assembly in the uncoupled position of FIG. 4;

FIG. 6 shows a side view of the feederhouse assembly with the actuator assembly in the coupled position of FIG. 3;

FIG. 7 shows a first perspective view of the actuator assembly;

FIG. 8 shows a second perspective view of the actuator assembly;

FIG. 9 shows a side view of a elements of a feederhouse assembly with a second example of an actuator assembly with the assembly in an uncoupled position;

FIG. 10 shows a plan view of the elements of FIG. 9;

FIG. 11 shows a first perspective view of a feederhouse assembly incorporating the second example of an actuator assembly with the actuator assembly in a coupled position;

FIG. 12 shows a first perspective view of a feederhouse assembly incorporating the second example of an actuator assembly with the actuator assembly in an uncoupled position;

FIG. 13 shows a side view of a portion of the feederhouse assembly showing the handles in a first position corresponding with the actuator assembly being in the uncoupled position;

FIG. 14 shows a side view of a portion of the feederhouse assembly showing the handles in a second position corresponding with the actuator assembly being in the coupled position;

FIG. 15 shows a perspective view of elements of the actuator assembly of FIG. 9;

FIG. 16 shows a perspective view of one of the lift actuators of FIG. 11; and

FIG. 17 shows elements of a retention apparatus for use with the present invention.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

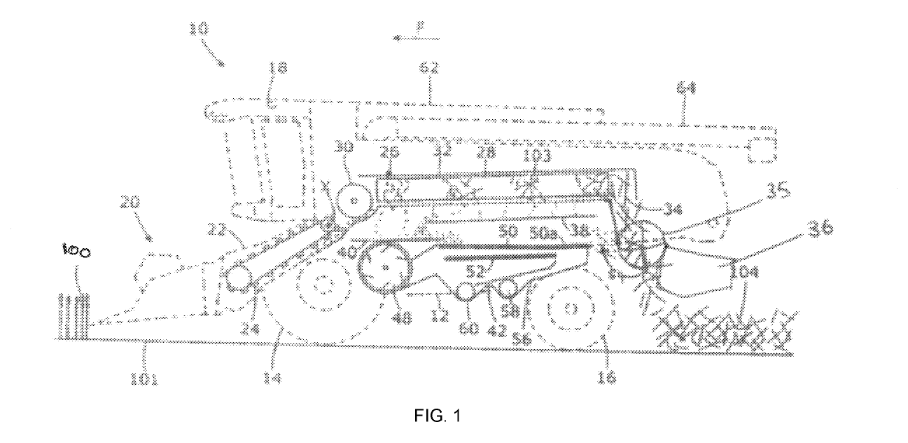

Relative terms such as forward, rearward, transverse, lateral, longitudinal and sideways will be made with reference to the normal forward direction of travel of the combine 10 and indicated by arrow F represented in FIG. 1. The terms vertical and horizontal will be made with reference to the level ground 101 upon which the combine 10 is disposed. In other words, the Cartesian axes of 'longitudinal', 'transverse', and 'vertical' are made in relation to the chassis 12 of combine 10 and are not affected by any slope in the ground. The terms "upstream" and "downstream" are made with reference to the general direction of crop flow along the material conveyance systems described.

FIG. 1 illustrates in schematic form the main components of the crop processing system of a combine harvester 10 and will be used to explain the flow of material below. The crop processing system is shown in solid lines whilst the outline profile of harvester 10 is shown in ghost form.

Combine harvester 10, hereinafter referred to as 'combine', includes a chassis 12 supported on front wheels 14 and rear steerable wheels 16 which engage the ground 101. A driver's cab 18 is also supported on the chassis 12 and houses a driver's station from where a driver controls the combine 10.

A cutting header 20 is detachably supported on the front of a feeder house 22 which is pivotable about a transverse axis x to lift and lower the header 20 in a conventional manner.

The combine 10 is driven in a forward direction (arrow F) across a field of standing crop 100 in a known manner. The header 20 serves to cut and gather the standing crop material before conveying such as a crop material stream into feeder house 22. An elevator 24, normally in the form of a chain and slat conveyor or elevator as shown, is housed within the feeder house 22 and serves to convey the crop material stream upwardly and rearwardly from the header 20 to the crop processor designated generally at 26. At this stage the crop material stream is unprocessed.

The crop processor 26 of the illustrated combine 10 includes a pair of axial flow threshing and separating rotors 28 fed by a tangential flow, crop material impelling, feed beater 30. It should be appreciated, however, that alternative types of crop processor may be used without deviating from the scope of the invention. For example, the crop processor may instead include a conventional tangential flow threshing cylinder with a plurality of straw walkers for separation. Alternatively, a single axial-flow processing rotor may be employed.

The feed beater 30 rotates on a transverse axis and comprises crop engaging deflectors (not shown) which convey the crop material stream under the beater and into rotor housings 32 which each house one of said rotors 28. It should be appreciated that only the left-hand rotor 28 and housing 32 is shown in FIG. 1 whereas the right-hand equivalent is hidden from view.

The rotors 28 are positioned to have a generally longitudinal, or fore and aft, rotation axis which is normally inclined upwardly towards the rear of the combine 10.

Flighting elements (not shown) provided on the front end of each rotor 28 engage the crop material stream which is then conveyed as a ribbon or mat 103 in a generally rearward axial and helical path in the space between the rotor 28 and the rotor housing 32.

The axial flow rotors 28 serve to thresh the crop stream in a front region, separate the grain therefrom in a rear region, and eject the straw residue via a straw discharge chute 34 provided below a rear portion of the rotors 28, the straw falling either directly onto the ground in a windrow, or via a straw chopper 35 and straw spreader 36 to be described in more detail later.

A part-cylindrical grate or concave 37 provided in the underside of each rotor housing 32 allows the separated material to fall by gravity onto either a return pan 38 located below a rear section of the processor 26, or directly onto a stratification pan 40 located below a front section of the processor 26. In reality, the separated material falling through the grate 37 is typically a mix of grain and material other than grain (MOG) which may include chaff, tailings and some straw.

The return pan 38 and stratification pan 40 together serve as a material conveyance system arranged to convey the separated crop material to a grain cleaning shoe designated generally at 42. The pans 38, 40 each include a respective linkage (not shown) to convert a torque source into oscillating motion to oscillate the pans in a generally fore and aft direction. Combined with a transversely rippled or corrugated floor, the oscillating movement of the return pan 38 and stratification pan 40 propels the material generally forwardly or rearwardly respectively.

The return pan 38 "returns" the separated material incident thereon towards the front of the combine 10 (in the direction F) to a front discharge edge 44 from where the material falls or cascades onto the stratification pan 40. The material on the stratification pan 40 is conveyed rearwardly to a rear discharge edge 46 from where the material falls into the cleaning system or "shoe" 42.

The grain-MOG mix falls from the rear discharge edge 46 into the cleaning shoe 42 where the cascading mix is subjected to a cleaning airstream generated by fan 48, before falling onto the front of upper sieve or chaffer 50.

Chaffer 50 comprises adjustable louvres supported on a frame which is driven in fore-and-aft oscillating manner. The material which settles on the chaffer 50 is conveyed in a generally rearward direction and the heavier smaller grain-rich material passes between the louvres onto an underlying lower sieve 52, whereas the lighter larger material (mostly chaff) passes to the end of the chaffer and out of the rear of the machine at shoe outlet 54. A rear section of chaffer 50a is commonly independently adjustable and is configurable to allow tailings to pass there through into a re-threshing region 56 from where the tailings are conveyed via a re-threshing auger 58 back to the processor 26.

Lower sieve 52 is also driven in an oscillating manner to convey the collected grain-MOG mix rearwardly wherein the material falling there through is collected by a clean grain auger 60 for conveyance to an elevator (not shown) for onward conveyance to a grain tank 62. Material which does not pass through lower sieve 52 and is instead conveyed off the rear edge thereof falls into re-threshing region 56 for subsequent re-threshing.

The airstream generated by fan unit 48 is also conveyed by ducting up through lower sieve 52 and chaffer 50 to encourage lifting of the MOG from the chaffer surface.

For completeness the combine 10 includes an unloading system which includes an unloading auger 64.

Aspects of the invention relate to an actuator assembly incorporating a safety stop assembly. The invention has particular use in relation to the feederhouse assembly of a combine harvester.

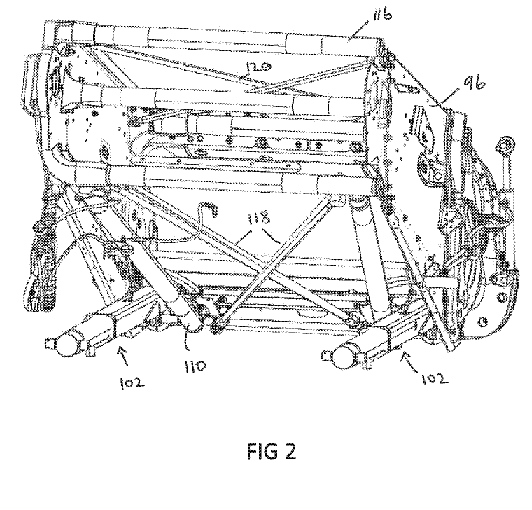

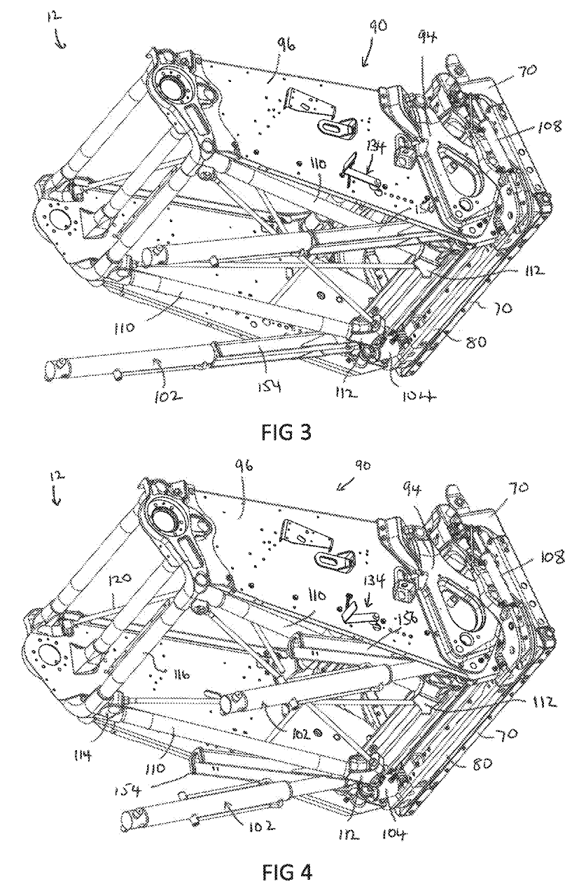

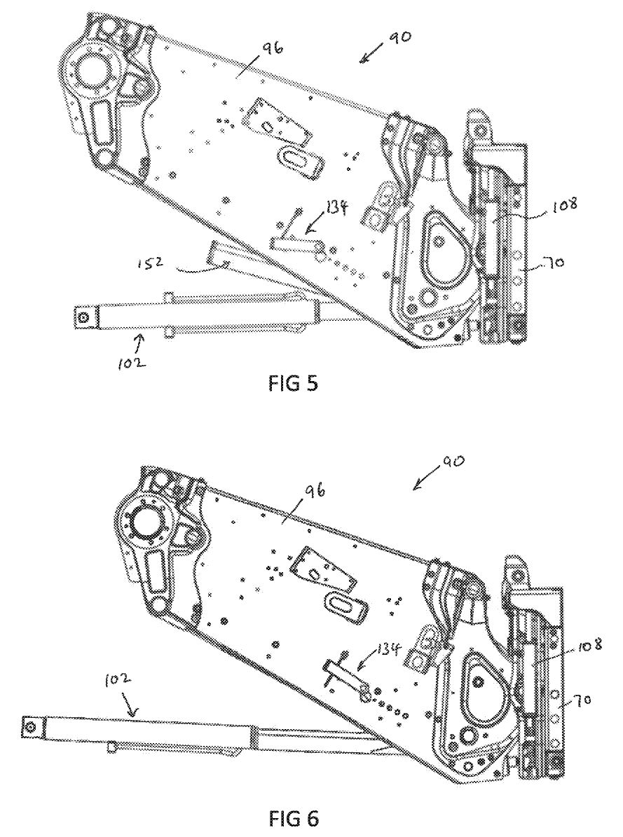

Referring first to FIGS. 2 and 3 perspective views of a feeder house assembly can be seen incorporating a safety stop mechanism for use with an actuator mechanism used to control the movement of a implement, such as a header, connected to a second end of the feederhouse assembly 12 in which the safety stop mechanism is in a coupled configuration.

The feederhouse assembly 12 houses a drive belt (not shown) mounted within a frame structure. The frame structure comprises a tilt frame 70 for connection to the header. The tilt frame 70 is rotatably adjustable about a longitudinal axis. The longitudinal axis extends in the for-aft direction of the combine. For a horizontal longitudinal axis, the rotation would be in a vertical plane, but the tilt frame 70 may in fact have a backward tilt so that the rotation is in a backward tilted plane. Tilting the tilt frame 70 raises one side of the cutting head 20 and lowers the other side so that the cutting head 20 remains at a constant distance to the ground when there is a lateral ground slope.

A pitch frame 80 is mounted behind the tilt frame 70. The pitch frame 80 is rotatably adjustable about a lateral axis, namely an axis extending horizontally across the lateral width direction of the combine. Adjusting the pitch frame 80 tips the top of the cutting head 20 forward or backward.

The pitch frame 80 connects to the front of an enclosed feederhouse framework 90, and the rear of the framework 90 has a pivotable connection to a chassis of the combine harvester.

There are actuators for controlling the various parts of the feederhouse assembly.

The lift actuators 102 connect to the front of the framework 90. They extend between a lift actuator bush, around a lift actuator pin at one end, and they connect to the combine harvester chassis at the other end, at a bush.

Pitch actuators 104 connect to the front of the framework 90. They extend between a pitch actuator bush, around a pitch actuator pin at one end and connect to the pitch frame 80 at the other end (again using a pin and bush arrangement).

Tilt actuators 108 connect between the tilt frame 70 and the pitch frame 80 (again with a pin and bush arrangement at each end). The tilt actuators 108 on opposite sides work in opposite directions to rotate the tilt frame 70.

The framework 90 is formed as a front housing section 94 which connects to the pitch frame 80 (via the pitch actuator 104) and a rear housing section 96.

First and second reinforcement bars 110 are provided at opposite lateral sides. These reinforcement bars 110 connect between the front and rear housing sections 94,96. In particular, they connect to the front housing section at the location of the lift actuator pin (and bush) and pitch actuator pin (and bush).

The reinforcement bars 110 connect to the lift actuator pin and pitch actuator pin. By this is meant there is a rigid connection between the end of the reinforcement bar and the pins, for example via a connector piece.

The two reinforcement bars 110 are located at the underside of the feederhouse assembly. A first end of each reinforcement bar connects to a cast front connector unit 112.

This front connector unit 112 connects a front end of the respective reinforcement bar 110 to a respective one of the lift actuator pins and to a respective one of the pitch actuator pins (which may be separate or together form a single pin as explained above). The connector unit 112 has an opening or openings for receiving the pins. Thus, the pins extend between the front housing section 94 and the connector unit 112. A rear end of each reinforcement bar 110 is connected to a rear connector unit 114. The two rear connector units are coupled together by a cross bar 116, and the rear connector units are formed as integral parts of the rear housing section 96. Thus, the rear housing section 96 may be considered to comprise the cast side parts, the connector units 114 and the cross bar 116.

The front and rear connection units 112, 114 make a further connection to first and second cross braces 118. A first cross brace is connected between the first (front) end of the first reinforcement bar and the second (rear) end of the second reinforcement bar and a second cross brace is connected between the second (rear) end of the first reinforcement bar and the first (front) end of the second reinforcement bar. These two cross braces together from an X brace to stabilize the two lateral sides.

The first and second reinforcement bars have a required stiffness, which is achieved by providing a large diameter and wall thickness. This may be determined by structural analysis. The moment of inertia of this component is important, to support vertical torsion loads, and hence a small diameter bar for example will not be sufficient because of the side load. The bars are formed as seamless tubes to enable high wall thickness and to avoid weak points. By way of example, the reinforcement bars 110 comprise tubes with a diameter between 70 mm and 80 mm.

The top of the feederhouse assembly also has an X brace 120. The two arms of the X-brace 120 are used to support the traction loads.

It is desirable in certain circumstances to prevent movement of the lift actuators 102 to prevent movement of the feederhouse assembly, for example to allow inspections and maintenance. Equally, movement of the feederhouse assembly should not otherwise be impeded. For this reason, it is known to incorporate safety stops into the feederhouse assembly design.

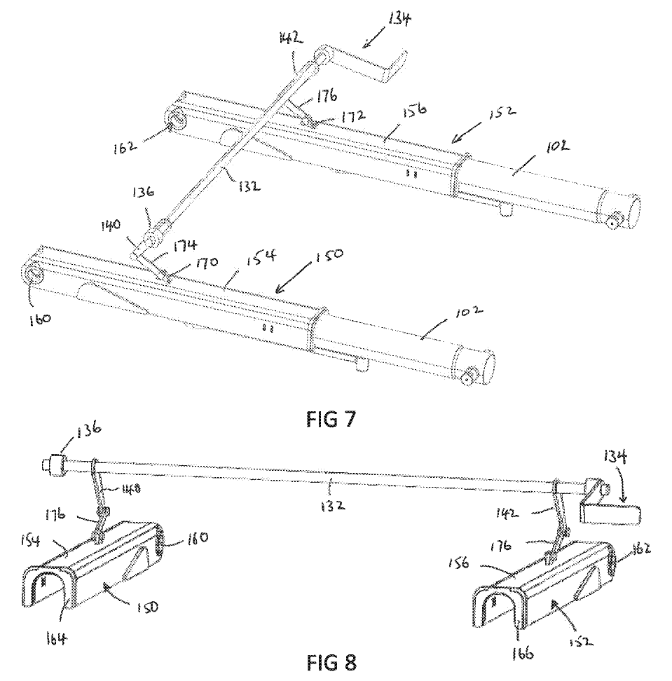

A first example of a safety stop assembly 130 is shown in FIGS. 2 - 8. The safety stop assembly 130 comprises a transverse rod or shaft 132 extending through and between each of the rear housing sections 96. Suitable bearings may be provided in each rear housing section 96 to support the shaft 132. As seen in FIGS. 7 and 8 a first end of the shaft 132 is provided with a substantially L-shaped handle 134 fixedly mounted for rotation with the shaft 132. The handle 134 is located externally of the adjacent rear housing section 96. A second end of the shaft 132 is provided with an abutment 136, in use, located externally of the adjacent rear housing section 96.

The shaft 132 is further provided with first and second levers 140, 142. Each of the first and second levers 140, 142 is fixedly attached, in any suitable manner, at a first end to the shaft 132 for rotation with the shaft 132.

Each of the first and second levers 140,142 is pivotally attached to a respective first and second coupling 174,176 carried from first and second safety stops 150,152. Each of the first and second safety stops is substantially U-shaped comprising an upper surface 154,156 and depending side walls. At a first end of each side wall, the safety stops 150,152 are provided with a mounting point 160,162, for example a bearing, at each side for rotation about an axis. At a second end of each safety stop 150,152, the safety stops 150,152 are provided with a substantially U-shaped end piece 164,166.

Each of the first and second couplings 174,176 are pivotally connected at a first end to a mounting point 170,172 provided on the upper surface 154,156 of the respective safety stop 150,152 and pivotally connected at a second end to a second end of a respective lever 140,142.

In the illustrated embodiment, the axis of rotation of the lift actuators 102 is coincident with the axis of rotation of the first and second safety stops 150,152.

In normal operation of the combine harvester, the safety stop assembly 130 is in the uncoupled position such that the lifting actuators 102 are free to operate. When an operation wishes to conduct maintenance, the handle 134 is moved to rotate the transverse rod about its axis to move the safety stops 154,156 into position to prevent movement of the lifting actuators 102.

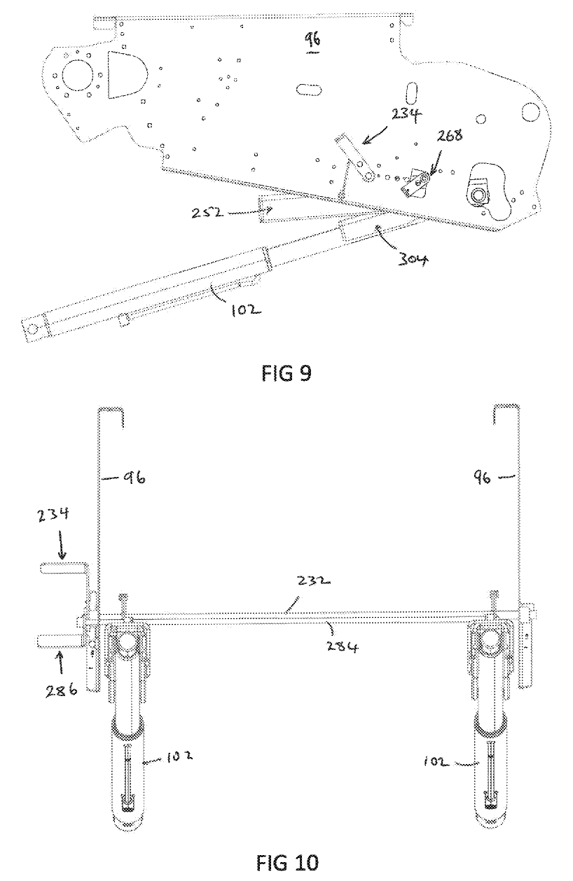

A second example of a safety stop assembly 230 is shown in FIGS. 9 - 16. As in the first example, the safety stop assembly 230 comprises a first transverse rod or shaft 232 extending through and between each of the rear housing sections 96. Suitable bearings may be provided in each front housing section to support the shaft 232. Again, a first end of the first shaft 232 is provided with a substantially L-shaped handle 234 fixedly mounted for rotation with the first shaft 232. The handle 234 is located externally of the adjacent rear housing section 96. A second end of the first shaft 232 is provided with an abutment 236, in use, located externally of the adjacent rear housing section 96.

The first shaft 232 is further provided with first and second levers 240,242. Each of the first and second levers 240,242 is fixedly attached, in any suitable manner, at a first end to the first shaft 232 for rotation with the shaft 232.

Again, each of the first and second levers 240,242 is pivotally attached to a respective first and second coupling 270,272 carried from first and second safety stops 250,252. Each of the first and second safety stops 250,252 is substantially U-shaped comprising an upper surface 254,256 and depending side walls 254,256. At a first end of each side wall, the safety stops 250,252 are provided with a mounting point 260,262, for example a bearing, at each side for rotation about an axis. At a second end of each safety stop 250,252, the safety stops 250,252 are provided with a substantially U-shaped end piece 264,266.

Each of the first and second safety stops 250,252 are provided in the upper surface 254,256 with an elongate window or opening 281,282 extending along a longitudinal axis of the respective safety stop 250,252.

Each of the first and second couplings 270,272 are pivotally connected at a first end to a mounting point 278,280 provided on an upper surface of the respective safety stop 250,252 and pivotally connected at a second end to a second end of a respective lever 240,242.

A second transverse rod or shaft 284 extending through and between each of the rear housing sections 96. Suitable bearings may be provided in each rear housing section to support the second shaft 284. A first end of the second shaft 284 is provided with a substantially L-shaped handle 286 fixedly mounted for rotation with the second shaft 284. The handle 286 is located externally of the adjacent rear housing section 96. A second end of the second shaft 284 is provided with an abutment 288, in use, located externally of the adjacent rear housing section 96.

The second shaft 284 is further provided with first and second levers 290,292. Each of the first and second levers 290,292 is fixedly attached, in any suitable manner, at a first end to the second shaft 284 for rotation with the second shaft 284.

Each of the first and second levers 290,292 is pivotally attached to a respective first and second coupling 294,296 carried from the respective lift actuator 102.

First and second inner safety stops 302,304 are provided within the respective first and second safety stops 250,252. The first and second inner safety stops 302,304 share an axis of rotation with the lift actuators 102 and the first and second safety stops 250,252.

Each of the first and second couplings 294,296 are pivotally connected at a first end to a mounting point 300 (cf FIG. 16) provided on the upper surface of the respective first and second inner safety stop 302,304 and pivotally connected at a second end to a second end of a respective lever 290,292. The first and second couplings 294,296 extend through the elongate opening 281,282 in the associated first and second safety stops 250,252.

In the illustrated embodiment, the axis of rotation of the lift actuators 102 is coincident with the axis of rotation of the first and second safety stops 250,252 and that of the first and second inner safety stops 302,304.

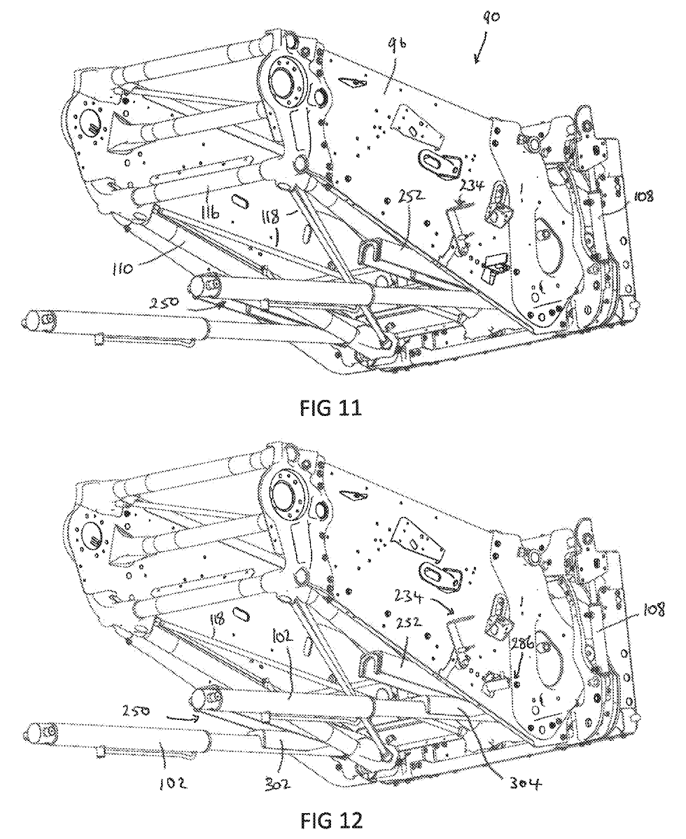

In use, movement of the first and second inner safety stops 302,304 is controlled by the handle 286. In a first position of the handle 286 (FIGS. 9,12 & 13) the first and second inner safety stops 302,304 are uncoupled from the lifting actuator 102 and retained within a respective first and second safety stop 250,252 and in a second deposition of the handle 286 (FIGS. 11 and 14) the first and second inner safety stops 302,304 are coupled to the respective lifting actuators 102 and have moved away from the respective first and second safety stops 250,252.

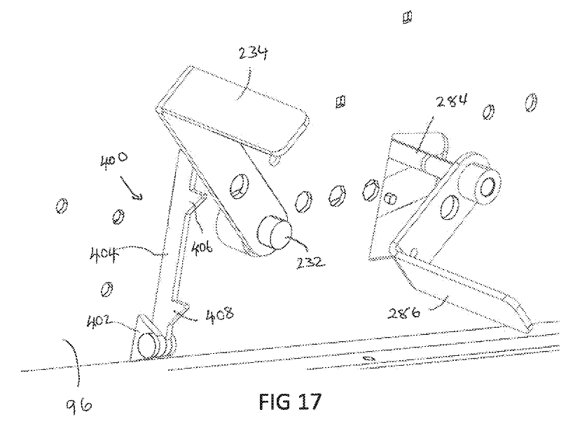

A retention mechanism 400 for use with the second safety stop assembly 230 is shown in FIG. 17. It will be appreciated that as the retention mechanism 400 may act on the handle 234 of the first transverse shaft 232 that a similar retention mechanism may be used for the first safety stop assembly 130.

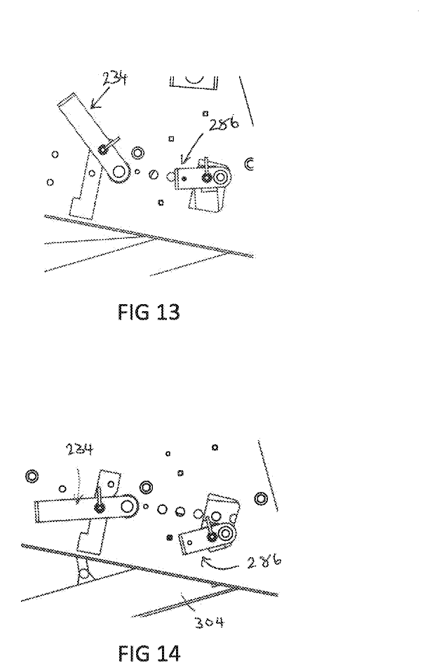

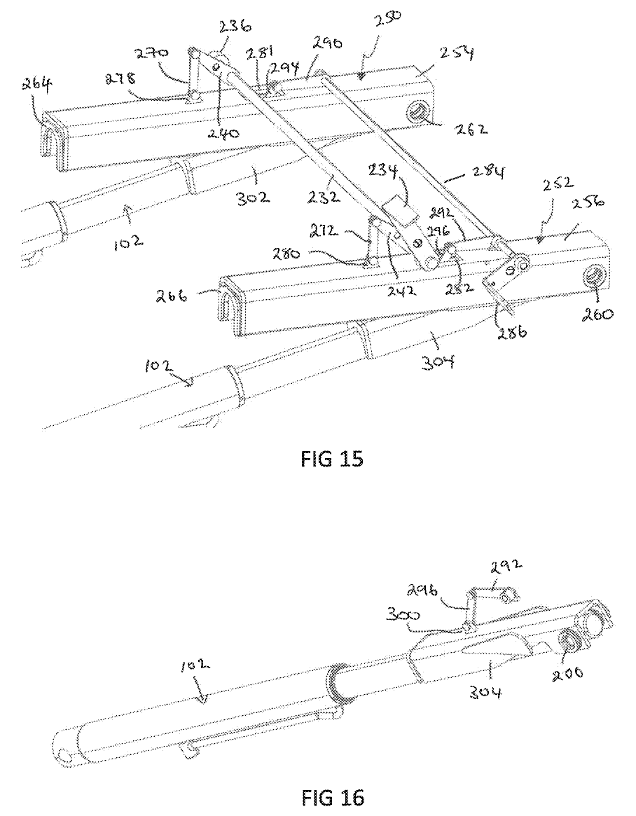

The retention mechanism 400 comprises a mounting 402 secured to an exterior of the rear housing section 96 and a pivotable element 404 secured to the mounting 402. The pivotable element 404 is provided with first and second abutment stops 406,408. Each abutment stop 406,408 includes an abutment surface and an inclined surface such that in a raised position the abutment surface of the first and abutment stops 406,408 prevent anticlockwise (downward) movement of the handle (as shown in FIG. 13) and so downward movement of the associated safety stops.

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of combine harvesters and component parts therefore and which may be used instead of or in addition to features already described herein.

What is claimed is:

1. An actuator assembly for moving an implement attached to an agricultural vehicle comprising left- and right-hand side actuators, arranged parallel to one another, each actuator attached to the implement at a connection point, a safety stop assembly comprising left- and right-hand side safety stops, arranged parallel to one another, each attached to the implement at a connection point, characterised in that the actuator assembly further comprises
a first transverse rod supported from the agricultural vehicle for rotation about a first axis, the first transverse rod being provided at one end with a handle to enable rotation of the transverse rod so as to move the safety stops between a coupled position and an uncoupled position and left and right-hand levers fixedly connected to the first transverse rod for rotation with the first transverse rod
mountings on each of the left- and right-hand side safety stops and
couplings extending between one of the mounting points and an associated lever, each coupling being mounted for rotation with respect to each of the mounting point and lever,
wherein the actuator assembly further comprises left and right hand side inner safety stops, a second transverse rod supported from the agricultural vehicle for rotation about a second axis, the second transverse rod being provided at one end with a handle to enable rotation of the second transverse rod so as to move the inner safety stops between a coupled position and an uncoupled position and left and right hand levers fixedly connected to the second transverse rod for rotation with the first transverse rod and left and right hand levers fixedly connected to the transverse rod for rotation with the first transverse rod,
mountings on each of the left- and right-hand side inner safety stops and
couplings extending between one of the mounting points and an associated lever, each coupling being mounted for rotation with respect to each of the mounting point and lever and extending through an opening provided in each associated safety stop.

2. An actuator assembly according to claim 1, characterised in that the actuator assembly further comprises a retention apparatus, the retention apparatus comprising a mounting secured to an exterior of the agricultural vehicle, a pivotable element secured to the mounting, the pivotable element provided with two or more abutment stops.

3. An actuator assembly according to claim 2, characterised in that each abutment stop includes an abutment surface and an inclined surface.

4. An actuator assembly according to claim 1, characterised in that the connection point of each left- and right-hand safety stop is coincident with the connection point of the respective left- and right-hand side actuator.
